(19) United States
(12) Patent Application Publication
(10) Pub. No.: US 2007/0209729 A1
(43) Pub. Date: Sep. 13, 2007

(54) Cable reinforcement for flexible ducts

(75) Inventors: Reg Tomerlin, Los Angeles, CA (US); David S. Larner, Fountain Valley, CA (US); Theodore R. Sonju, Cypress, CA (US)

Correspondence Address: FULWIDER PATTON LLP, 200 OCEANGATE, SUITE 1550, LONG BEACH, CA, 90802, US

(73) Assignee: Arrowhead Products Corporation

(21) Appl. No.: 11/371,532

(22) Filed: Mar. 9, 2006

(51) Int. Cl. F16L 11/00

(52) U.S. Cl. 138/133; 138/122

(57) ABSTRACT

A flexible fire resistant duct constructed of a flexible fire resistant membrane forming a tube and reinforced with a metallic multi-strand cable.

### FIELD OF THE INVENTION

The present invention relates to a flexible fire resistant duct for circulating fluid to or from various locations within a common carrier.

### BACKGROUND OF THE INVENTION

Common carriers such as aircraft, automobiles, naval vessels and trains require the circulation of air and gases within specific areas for controlling the environment and to vent certain areas. To accomplish such circulation, many vehicles employ ducts to carry and circulate the gas from one area to another. The use of ducts to circulate gas is commonly known as an environmental control system (“ECS”). The ducts carry positive and sometimes negative fluid pressure. In practice, these ducts are installed as the airplane or air ship reaches the final stages of assembly and most components have already been installed thereby leaving little space for installation and manipulation of the duct. The ducts must then be sufficiently flexible to be threaded through circulation paths in an aerospace vehicle, often times bent and flattened during installation resulting in permanent deformation thus impinging on the efficiency of flow thereon.

It is known to those skilled in the art that in the event of combustion, the walls of any such ducts may well be exposed directly to flame and high temperature. The duct wall and any reinforcement should then resist combustion. While metal wire reinforcement might resist such high temperatures and combustion it is subject to taking a permanent set should the duct be flattened as it be drawn through an often circuitous path winding around fuselage framework and bulky components upon installation mentioned thereon. While less subject to permanent deformation upon bending, polymer reinforcing chords often do not exhibit resistance to high temperature and flame.

In recognition of the fact reinforced ducts must carry pressurized fluids, it has been proposed to substitute spirals of hard resin laminated within the soft resin walls. A device of this type is disclosed in U.S. Pat. No. 6,382,258 to Tanaka. While serving to reduce twist in the duct under load, such resin spirals have limited resistance to combustion.

Recognizing the need for ducts to provide radial strength and compressibility, it has been proposed to reinforce a duct with a stiffening element built into the duct walls. A device of this type is disclosed in U.S. Pat. No. 6,815,026 to Philp. Such duct designs serve to resist compressibility but lack the ability to restore their profile adequately when deformed by external pressures.

Further attempts at reinforcing ducts used multiple material layers surrounding a metallic helical winding as proposed in U.S. Pat. No. 6,843,278 to Espinasse and Publication No. US 2004/0060610 to Espinasse. While serving to prevent the formation of shrinkage cavities between layers, these layers add to the combustibility content of the duct and pose a risk for flammability. Additionally, the single wire reinforcement used contributes to resiliency problems and subjects the ducts to collapse without restoration after exposure to the environmental stresses within for example, an airframe.

In unrelated areas, such as the manufacture of hoses for transferring corrosive liquids or for use in off-shore drilling, it has been known to construct elastomeric reinforced walls that are heat resistant. However, these hoses also include a higher amount of combustible materials and suffer from heavy weight that is not conducive to the economics of load management in airplane construction. Thus, a need exists in the marketplace for a flame resistant flexible duct that can inherently restore itself to a distended state after suffering a crimping or flattening.

### SUMMARY OF THE INVENTION

Briefly and in general terms, the present invention is directed to a fire resistant flexible duct used to transfer fluid within a common carrier that resists permanent deformation upon being bent and controlled. The duct of the present invention is constructed of polymeric materials reinforced by a multi-strand cable. The cable may be composed of several fine strands of either a metal, such as steel or polymer. In one preferred embodiment, the cable is coated with a heat resistant varnish before it is adhered to a polymer wall. We have discovered that a flexible wall duct reinforced by a multi-strand cable can be bent and manipulated during, for instance, installation but yet will return to its original distended configuration when deformation forces are released.

To provide support and shape for the duct, the reinforcing cable may be attached to the either the exterior or interior of the wall in a helical fashion to provide the duct wall flexibility while tending to maintain the overall tubular form. In one preferred embodiment, the cable is helically wound about the exterior of the wall. Placing the cable on the exterior of the wall provides less drag on fluids traveling within the duct improving efficiency and minimizing the power and energy required to transfer the fluids. The cable is composed of a durable, flexible, heat resistant material. In one preferred embodiment, the cable is formed from stainless steel strands which contribute to increased flexibility and compressibility of the duct while simultaneously increasing flame resistance by reducing the amount of combustible materials. A coating of a polyimide varnish may be applied to the cable increasing both stiffness of the cable by virtue of the varnish and the flammability because of the polyimide properties.

To maximize safety and enhance durability, the duct may also encompass other embodiments that assist in providing flame resistance. In one preferred embodiment a thin rubber coating on a fiberglass fabric may be used to form the wall. Using fiberglass fabric that meets flammability standards serves to cut down on the amount of combustible material in the duct. In one embodiment, the fiberglass fabric side of the wall faces radially outwardly where it will be first to contact heated components of the carrier in the event of fire in nearby components. In the embodiments, the thin rubber coating may face the interior of the wall to decrease friction on fluid traveling within the duct.

Other features and advantages of the invention will become apparent from the following detailed description, taken in conjunction with the accompanying drawings which illustrate, by way of example, the features of the invention.

### BRIEF DESCRIPTION OF THE DRAWINGS

FIG. 1 is a perspective view of a membrane being wrapped on a mandrel to form a tube wall that may be incorporated in the duct of the present invention;

FIG. 2 is a partial sectional view, in enlarged scale, taken along the line of 2-2 in FIG. 1;

FIG. 3 is a partial cross-sectional view, in enlarged scale, taken along the line of 3-3 in FIG. 4;

FIG. 4 is a perspective view showing a cable being drawn through an adherence bath wrapped on the tube wall being made in FIG. 1;

FIG. 5 is a cross-sectional view, in enlarged scale, taken along the lines of 5-5 in FIG. 4;

FIG. 6 is a transverse sectional view, in enlarged scale, taken along the mandrel and both shown in FIG. 4;

FIG. 7 is a cross-sectional view, in enlarged scale, taken along the line 7-7 in FIG. 1;

FIG. 8 is a cross-sectional view, in enlarged scale, taken along the lines 8-8 in FIG. 4;

FIG. 9 is a cross-sectional view similar to FIG. 8 but with mandrel removed;

FIG. 10 is a cross-sectional view, in enlarged scale, taken along the lines 10-10 of FIG. 9;

FIG. 11 is a cross-sectional view, in enlarged scale, taken from the cable 11 in FIG. 10 showing a cable coated in a varnish and attached to the membrane by an adhesive;

FIG. 12 is a broken vertical sectional view, in reduced scale, of the duct shown in FIG. 9 threaded through a path in an aerospace frame;

FIG. 13 is a sectional view, in enlarged scale, showing the duct passing through frame openings, taken along the line 13-13 in FIG. 12; and

FIG. 14 is a sectional view, in enlarged scale, showing the duct traveling over a beam support of the frame, taken along the line 14-14 in FIG. 12;

FIG. 15 is a perspective view similar to FIG. 1 of a membrane being wrapped on a mandrel longitudinally in cigarette style to form a tube wall that may be incorporated in the duct of the present invention;

FIG. 16 is a perspective view similar to FIG. 1 showing a membrane wrapped with edges overlapping each other in cigarette style forming a tube wall;

FIG. 17 a perspective view showing a cable being drawn through an adherence bath wrapped on the tube wall being made in FIGS. 15-16.

### DETAILED DESCRIPTION OF THE PREFERRED EMBODIMENTS

The lightweight flexible flame resistant reinforced duct 22 of the present invention includes, a flexible membrane tube wall 30 constructed of a polymer film which may be on fiberglass fabric and encased in a multi-strand spiral cable 32 attached along the wall to provide distension and reinforcement. Referring to FIG. 5, the cable 32 is formed by grouping multiple strands together and may be coated in a polyimide varnish 34 before it is attached to the to the wall 30 by means of an adhesive 42, (FIGS. 10-11).

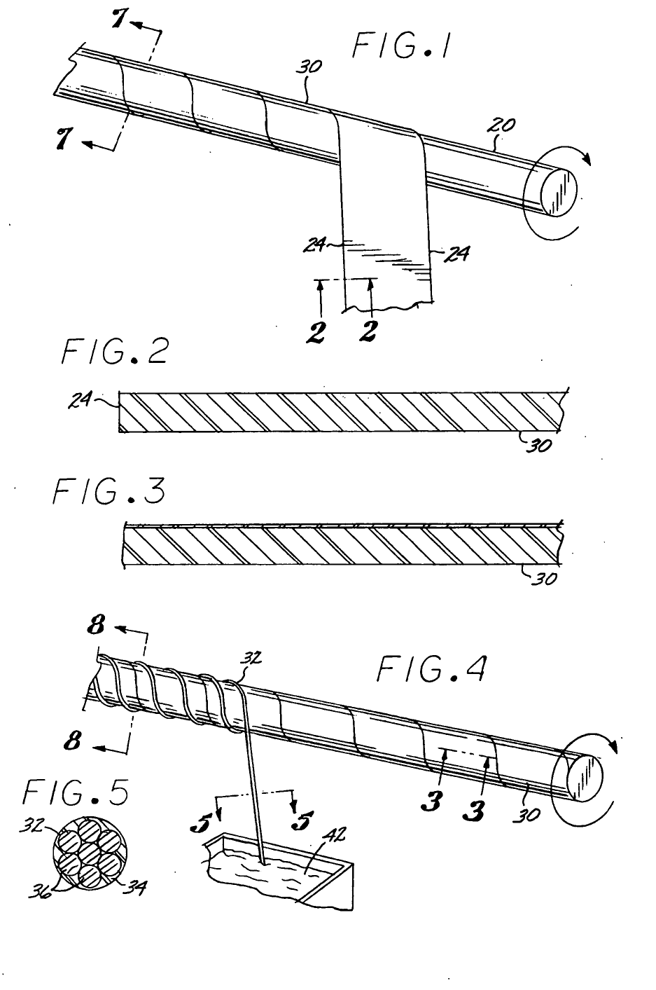

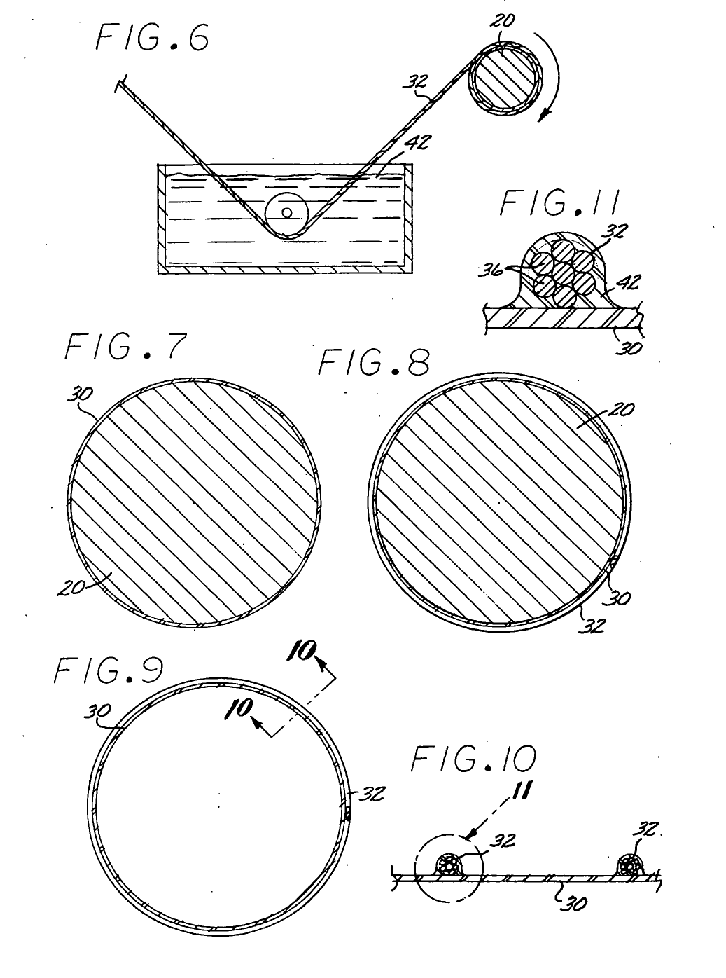

In one preferred embodiment, referring to FIGS. 1 and 15, the duct is formed by wrapping the edges of the membrane 30 over a mandrel 20 and sealing any seams with an adhesive. Once the tube wall is formed, the metallic cable 32 is wrapped about the membrane and mandrel and attached to the membrane by an adhesive 42.

Commercial transport aircraft typically make use of flexible ducting for transport of various fluids within the aircraft frame for controlling the temperature of various components such as electronic racks or for transporting exhaust gases. Ducts of widely varying diameters are routed throughout an aircraft for circulating negative to moderate and high-pressure (3-100 psi) fluids. For safety reasons, it is desirable that the materials in the ducts, like other structural materials in the craft, be resistant to flame and high temperatures and preferably self-extinguishing once any direct flame contact has been discontinued. Recognitions of these desirable characteristics are reflected in the FAA regulation for flammability, FAR 25.856. Metallic wire reinforcement serves to distend the duct wall and meets flammability requirements but lacks flexibility and compressibility desirable in routing ducts through non-linear passages. Such wire reinforced ducts are often compressed during installation and fail to restore the duct to a suitable cross-section.

The membrane wall 30 may be constructed of a thin polymer type film coating on a fire resistant fabric typically about 0.030 inches thick. In one embodiment, the film is a polymide, such as Kapton® or polyetherether ketone film. In one preferred embodiment, a fire resistant rubber film is placed on fiberglass, (FIGS. 2-3). Referring to FIGS. 7-9, this membrane is then wrapped around a tooling mandrel to form the tubular shape. The mandrel may be about 2 to 3 inches in diameter or larger to form the duct wall of a corresponding diameter. Preferably the fiberglass fibers are oriented into place biased about 45 degrees to the axis of the duct and provide favorable stress patterns when the duct is pressurized. In another embodiment, the membrane is formed by coating the fabric with silicone.

Referring to FIGS. 15-17, a convenient method of making the tube wall 30 is to wrap a thin flexible fire resistant rubber coated fiberglass sheet around a mandrel in cigarette paper fashion where the opposite edges 24 overlap each other creating a seam 26 and are adhered to each other by using a fire resistant adhesive. After forming the tube on the mandrel, the cable 32, with or without a polyimide coating 34, may be wound onto the mandrel 20 in a helical fashion over the membrane wall 30 and adhered thereto. Another approach is to wrap a strip of such sheet around the mandrel in a helical pattern as shown in FIG. 1. The membrane may be fed onto the mandrel as it is rotated about its own longitudinal axis to wind the membrane thereon in a helical pattern to form a tube as shown in FIG. 4. In one embodiment, the opposite edges 24 of the membrane are coated with a fire resistant adhesive and are fed onto the mandrel to cause such edges to overlap and adhere the adjacent helices together.

In practice, the cable 32 is constructed from stainless steel fine strands 36 constructed to itself be not distendable but to provide high tensile strength and high flexibility. The strands may be interlaced or spirally twined together to form the cable. We have discovered that cable on the order of 0.031 to 0.0032 inches and having about seven strands works well. The cable may be further stiffened by applying a thin coat of polyimide varnish (FIG. 4). The varnish or other coating should be cured at a high temperature range between 600 to 800 degrees Fahrenheit.

As will be appreciated by those skilled in the art, the strengthening attribute of the polyimide coating 34 allows the metallic cable to be constructed with a smaller diameter. Depending on the thickness of the coating, the radial thickness of the cable may be correlatively decreased while maintaining its structural integrity. After the cable is coated, a fire resistant adhesive 42 is used to attach the cable to the membrane wall, (FIGS. 10-11). In a preferred embodiment, the cable is wrapped helically about the exterior of the membrane wall providing shape and reinforcement to the wall.

With the construction described, it will be appreciated that the craftsman can readily determine the configuration of components which might be required for an application such as for the flowing air in exchange relationship with elected components. It is desirable to control the transfer of cooling air into the interior of the craft to maintain the components at a temperature to function properly, for example, microprocessors in the guidance systems.

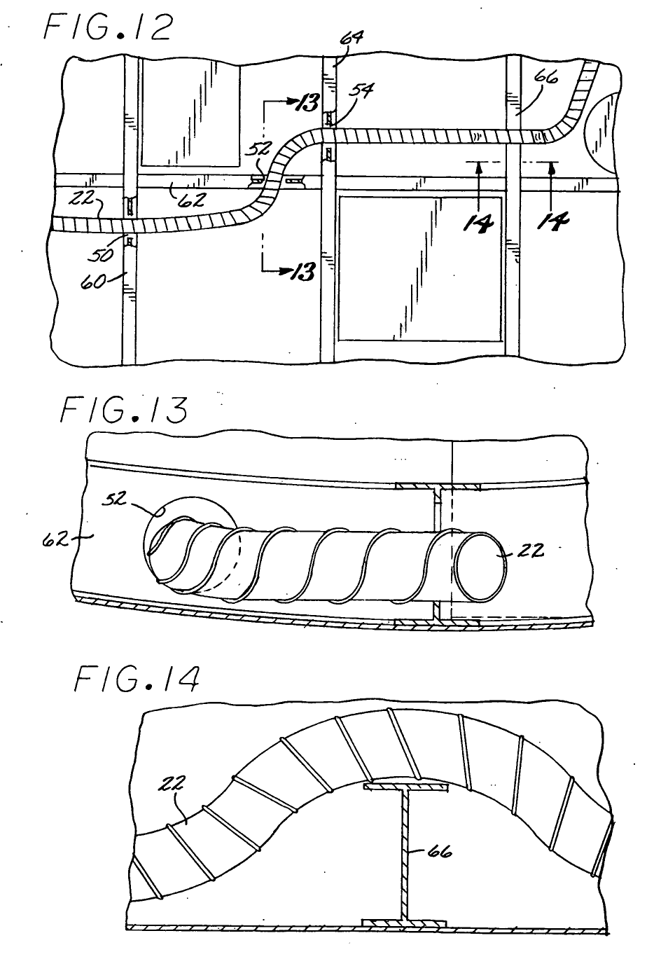

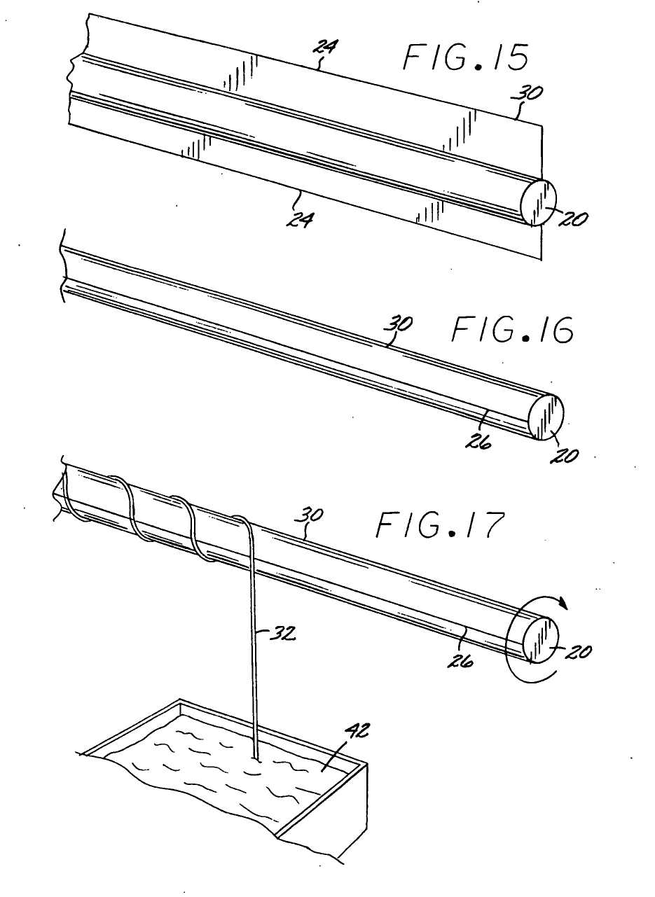

It will be appreciated that the flexibility of the duct allows a duct installer to thread the duct within the frame around and through various components as shown in FIGS. 12-14. During installation of ducting, many of the common carrier frame components cooperate to define a rather tortuous path subjecting the ducts to many bends and turns as it is snaked into position.

It will also be appreciated that the present invention provides a flammability resistant and compressible duct that can be constructed of various lengths for passage within a variety of common carrier frames such as airplanes, automobiles, boats, trains, and space vehicles. The design of the present invention will pass the most stringent current specifications for flammability and stiffness. The materials used allow for a safer and more efficient means of transporting fluids about a common carrier.

For example, the cable used for providing reinforcement in combination with the flexibility of the membrane walls provides a resiliency to the duct that allows the duct to restore its shape after compression. Multiple fine strands interlaced together create relatively low resistance to bending while cooperating to, in the combination shown, maintain the duct wall distended. Of equal importance is the fact that the multiple small strands of the cable afford, when the walls are flexed radially inwardly from diametrical opposite sides, substantial flexibility to provide for bending to a great degree without exceeding their individual yield points thus causing the individual helix to assume their original circular shape when external forces are released. Those skilled in the art will also appreciate that stainless steel cables are less expensive to produce than polymer made cables thereby providing a desirable economic alternative.

It will further be appreciated that the overall combination of materials lends the duct to a relatively high resistance to flammability. The cable constructed of metal strands or fire resistant polymer affords resistance to combustion. Metal strands, likewise, hold higher flammability tolerances than polymer wires further contributing to the flammability resistance of the duct. In one preferred embodiment, where stainless steel strands are used, the operating temperature of the reinforced ducts increases from 250 degrees Fahrenheit to 500 degrees Fahrenheit. When the cables are coated with a polyimide varnish, flammability is further regulated because the fire resistant properties of the polyimide. Additionally, the membrane wall, in a preferred embodiment, is a fire resistant fabric such as fiberglass and is coated with a fire resistant rubber film. Those skilled in the art will appreciate that such a flammability resistant coating also creates a degree of self-insulation within the duct.

In operation, the duct will be constructed with a reinforcing cable having a helical pitch of approximately 0.2. When a woven cable is wrapped in a helix about a ducting of about 2 to 3 inches in diameter and is adhered to the duct wall, the cable behaves like a spring and has an inherent tendency to straighten from its circumferential disposition and distends the duct wall diametrically outward to a cylindrical configuration providing a cylindrical passageway. Such a construction utilizing in combination a flexible membrane and metal cable overall affords a higher resistance to deformation and damage that occurs, for example, from crimping against edges, mishandling, or vacuums creating a negative pressure within the duct. In operation, the duct may be flattened and crushed to less than half its diameter yet inherently tends to restore its cross-section and assume a cylinder configuration to provide an efficient flow of fluid.

In practice, in the construction of airframes, the ducting is added near the end of manufacture. The labor and materials required to install ducting at that point may costs millions of dollars so efficiency and ease of installation are important. During installation, ducting is often snaked through torturous and convoluted paths. In one instance, referring to FIG. 12, a 787 Boeing airplane with such paths is shown with ducting that is snaked through openings 50, 52, and 54 and through frames 60, 62, 64, and over frame 66. The duct is often crushed diametrically and flattened while snaked through such tight and rigid structures. However, the construction of a duct with rubber walls and reinforcing metallic strand cables resists not only resists damage to the duct, but provides it with restored distendablity sufficient for efficient fluid flow.

The user friendliness and quick connectability of the duct will also be apparent. Owing to its flexibility and resilience, less care is required around the duct's snaking and connecting within an airframe. In the event of component failure, the duct provides for simple disconnection, movement, and reconnection to a working component.

From the foregoing, it will be apparent that a flexible fire resistant duct of the present invention provides a safe and economic means for fabricating a resilient and adaptable duct to provide for directed fluid flow through the framework of a common carrier.

We claim:

1. A lightweight fire resistant flexible duct for transferring fluid through a path on a common carrier, comprising:
a fire resistant, flexible membrane configured to form a tubular wall;
a flexible multi-strand cable disposed in a helical pattern along the wall adhered thereto and constructed to flexibly maintain the wall distended.

2. The flexible duct of claim 1 wherein:
the flexible membrane is a rubber film coating on a fabric.

3. The flexible duct of claim 1 wherein:
the cable is formed by multiple strands of metal.

4. The flexible duct of claim 3 wherein:
the metal cable is formed by multiple strands of stainless steel.

5. The flexible duct of claim 1 further comprising:
a polyimide varnish coating the cable.

6. The flexible duct of claim 1 wherein:
the cable is constructed of seven strands.

7. The flexible duct of claim 1 wherein:
the membrane is formed using a polymer film.

8. The flexible duct of claim 1 wherein:
the cable is 0.031 to 0.032 inches in diameter.

9. The flexible duct of claim 1 wherein:
the tubular wall is formed using silicone.

10. The flexible duct of claim 1 wherein:
the cable is formed by woven interlaced strands.

11. The flexible duct of claim 1 wherein:
the cable is formed by spiraling strands.

12. The flexible duct of claim 1 wherein:
the membrane is spirally wound to form a helical tubular wall.

13. The flexible duct of claim 2 wherein:
the fabric is made from fiberglass.

14. The flexible duct of claim 1 wherein:
the flexible strand cable is wound about the tubular wall in a helical pattern.

15. The flexible duct of claim 1 wherein:
the flexible multi-strand cable is resilient and configured to, when adhered to the tubular wall, caused such tubular wall to assume a cylindrical configuration.

16. The flexible duct of claim 1 wherein:
the multi-strand cable is constructed to, in its unconstrained condition, distend the tubular wall to a selected cross section and being sufficiently flexible to, in the event the wall is pressed radially inwardly from its opposite sides to flex the wall and cable to a cross section one half the selected cross section, flex the wall and cable back to the predetermined cross section.

17. The flexible duct of claim 1 wherein:
the tubular wall and multi-strand cable are so configured and arranged as to cause the cable to distend the wall to an unrestrained cylindrical configuration and the cable has sufficient resiliency to upon sufficient external forces being applied diametrically to the wall, cooperate with the wall to radially inwardly to a cross section of one half its unrestrained diameter and to, when such forces are released, recover to its unrestrained cylindrical configuration.

18. A method of constructing a fire resistant flexible duct including:
wrapping a fire resistant flexible polymer film around a mandrel to form a tubular wall;
selecting a flexible reinforcing multi-strand cable;
coating the cable with an adhesive;
winding the cable spirally around the tubular wall and mandrel adhering the cable to hold the wall resiliently distended; and
extruding the duct from the mandrel.

19. An airframe formed with a circuitous passage:
a flexible fire resistant membrane defining a flexible tubular wall projecting through the circuitous passageway;
a multi-strand reinforcing cable disposed in a helical pattern about the tubular wall and attached thereto to flexibly maintain the wall distended.

20. The airframe of claim 19 wherein:
the cable is constructed of stainless steel strands.
